(19) United States
(12) Patent Application Publication
(10) Pub. No.: US 2016/0046071 A1
(43) Pub. Date: Feb. 18, 2016

(54) APPARATUS FOR PEELING IN THE PRODUCTION OF THREE DIMENSIONAL OBJECTS

(71) Applicant: Mark Laurence Kuhnlein, Hsinchu (TW)

(72) Inventor: Mark Laurence Kuhnlein, Hsinchu (TW)

(21) Appl. No.: 14/821,840

(22) Filed: Aug. 10, 2015

Related U.S. Application Data
(60) Provisional application No. 62/038,371, filed on Aug. 18, 2014.

(51) Int. Cl. B29C 67/00; B29C 33/44

(52) U.S. Cl. CPC B29C 67/0066; B29C 67/0092; B29C 33/442; B33Y 30/00

(57) ABSTRACT

An apparatus for peeling in the production of three-dimensional objects is provided. The apparatus, disposed underneath a transparent bottom separation layer of a tank of a stereolithography apparatus allowing light from a light source to pass through the tank to solidify the liquid photopolymer contained in the tank, includes a tilt plate, a pivot connector, and a tilt actuator to move the tilt plate to separate an underneath support for the transparent bottom separation layer from the transparent bottom separation layer to create a slack of the transparent bottom separation layer of the tank to ease the peeling process in producing 3D objects.

### CROSS-REFERENCE TO RELATED APPLICATION

The present application is based on, and claims priority from, U.S. Provisional Application No. 62/038,371, filed Aug. 18, 2014, the disclosure of which is hereby incorporated by reference herein in its entirety.

### TECHNICAL FIELD

The technical field generally relates to an apparatus for peeling in the production of three-dimensional, and particularly to an apparatus for assisting the peeling step in three-dimensional printing through stereolithography.

### BACKGROUND

Three-dimensional printing (3D printing) uses an additive process to lay down successive layers of material under computer control to create an object of almost any shape or geometry. in recent years, the rapid development and maturity of 3D printing has attracted various applications, ranging from manufacturing to medical fields.

Various additive processes have been developed over the past decades. The main differences between processes are in the way layers are deposited to create parts and in the materials that are used For example, with laminated object manufacturing (LOM), thin layers of material, such as paper, polymer, metal, and so on, are cut to shape and joined together. Other methods melt or soften material to produce the layers, such as selective laser melting (SLM) or direct metal laser melting (MILS), selective metal sintering (SLS), fused deposition modeling (FDM), or fused filament fabrication (FFF). A different approach is to cure liquid materials using different sophisticated technologies, such as stereolithography (STA).

Stereolithography was patented by Hull in 1986 as a method and apparatus for making solid objects by successively “printing” thin layers of an ultraviolet curable material, one on top of the other. The patent described a concentrated beam of ultraviolet light focused onto the surface of a tank filled with liquid photopolymer. The light beam draws the object onto the surface of the liquid layer by layer, using polymerization or cross-linking to create a solid, a complex process which requires automation. Based on the incoming direction of the light, the stereolithography can be categorized as a top-down type or bottom-up type. Bottom-up stereolithography usually includes a series of exposure steps and separation phases, wherein the exposure step is to solidify the photopolymer and the separation step is to raise the solidified photopolymer layer to separate it from the tank bottom. The separation step is also referred to as peeling by the industry.

However, a major issue often encountered in the actual application of stereolithography is the peeling/separation process, wherein a newly solidified layer of the polymer attached to the previously solidified layers is separated from the tank bottom to create a smooth layer surface without breaking the newly solidified layer from the previous layers. Different solutions are proposed to address the adherence of the newly solidified layer to the tank bottom during the separation step of the current stereolithography process. For instance, a flexible, elastic separating layer made of non-stick material is used at the bottom of a tank containing the liquid polymer to ease the peeling of the newly solidified layer from the liquid polymer in the tank. Another proposed technique is, after a polymer layer has solidified and adhered to the bottom of the tank, the bottom of the tank is peeled from the polymer layer adjacent to an anchored portion of the tank and partially moves upwards to create an ease of separation.

As the separation of the newly solidified layer from the tank bottom remains a critical factor in the performance of stereolithography, it is desirable to devise an effective solution to ensure the smooth execution of the peeling step.

### SUMMARY

An exemplary embodiment describes an apparatus for peeling in the production of three-dimensional (3D) objects with a long-lasting layer separation material. The apparatus for peeling in the production of three-dimensional objects is applicable to a 3D printer having a build platform assembly, further including a build platform to attach to a three-dimensional object to be produced, a build arm to hold the build platform, one or more support guides to support the build arm and an actuator to move the build arm holding the build platform along the z-axis linearly; a tank to hold a liquid photopolymer, the tank having a transparent or translucent bottom separation layer to allow light from a light source to pass through the transparent bottom separation layer of the tank to solidify the liquid photopolymer; and a main support frame to attached to the tank to support the tank. The apparatus for peeling in the production of three-dimensional objects is disposed underneath the transparent bottom separation layer of the tank, including a transparent top plate to support the transparent bottom separation layer of the tank when in an ‘up’ position; a lower support frame, disposed underneath the transparent top plate to support the transparent top plate; a tilt plate, connected by a pivot connector to the main support frame of the 3D printer; and a tilt actuator, disposed opposite to the pivot connector underneath the tilt plate to move the tilt plate along with the transparent top plate and the lower support frame downwards to a ‘down’ position to separate the transparent top plate from the transparent bottom separation layer of the tank.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of an embodiment of a 3D printer according to an exemplary embodiment;

FIG. 2 shows a cross-sectional view of the details of the tank and the apparatus for peeling in the production of three-dimensional objects according to the embodiment in FIG. 1;

FIG. 3 shows a schematic view of the apparatus for peeling in the production of three-dimensional objects of the embodiment in an ‘up’ position;

FIG. 4 shows a schematic view of the apparatus for peeling in the production of three-dimensional objects of the embodiment in a ‘down’ position;

FIG. 5 shows a schematic view of an apparatus for peeling in the production of three-dimensional objects according to another exemplary embodiment; and

FIG. 6 shows a schematic view of another embodiment of a 3D printer according to an exemplary embodiment.

### DETAILED DESCRIPTION OF THE DISCLOSED EMBODIMENTS

In the following detailed description, for the purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

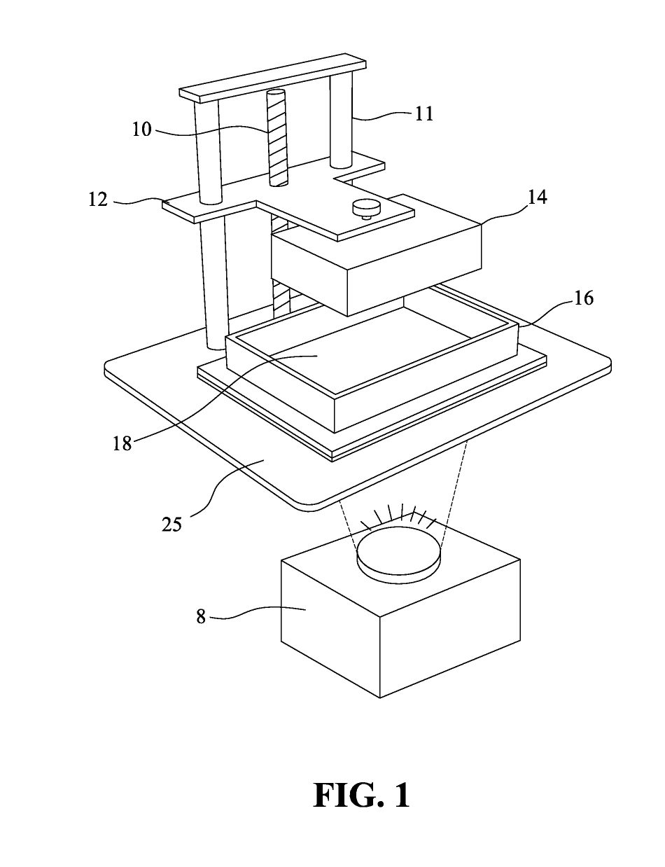

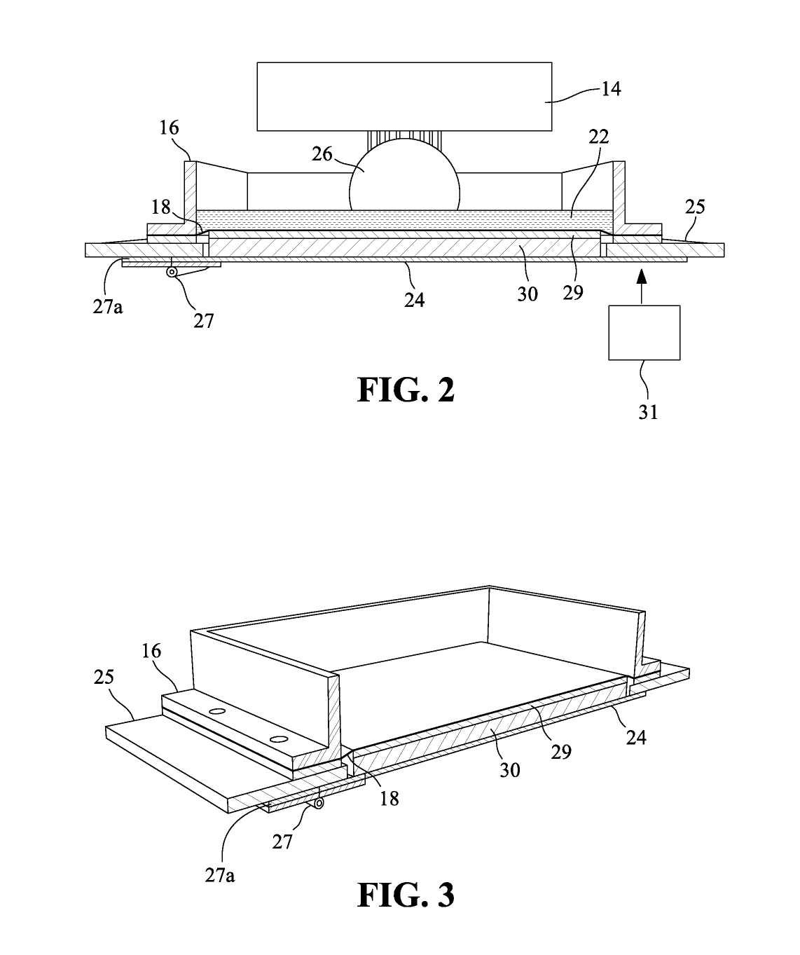

Refer to Both FIG. 1 and FIG. 2. FIG. 1 shows a schematic view of a 3D printer, and FIG. 2 is a cross-sectional view showing the details of the tank and the apparatus for peeling in the production of three-dimensional objects according to the embodiment in FIG. 1. As shown in FIG. 1, the 3D printer of the present embodiment includes a platform assembly, further including a build platform 14 to attach to an three-dimensional object (labeled 26 in FIG. 2) to be produced, a build arm 12 to hold the build platform 14, one or more support guides 11 to support the build arm 12 and an actuator 10 to move the build arm 12 holding the build platform 14 along the z-axis linearly; and a tank 16 to hold a liquid photopolymer 22, the tank 16 having a transparent or translucent bottom separation layer 18. The 3D printer also includes a main support frame 25 to attach to and support the tank 16. A light source 8 provides the light from below to solidify a liquid photopolymer in the tank 16 layer by layer. As shown in FIG. 2, the 3D printer of the present embodiment further includes an apparatus for peeling in the production of 3D objects of the present invention, disposed underneath the transparent bottom separation layer 18 of the tank 16, to allow light from a light source (labeled 8 in FIG. 1) to pass through the transparent bottom separation layer 18 of the tank 16 to solidify the liquid photopolymer 22. The apparatus for peeling in the production of 3D objects further includes a transparent top plate 29 to support the transparent bottom separation layer 18 of the tank 16 when in an ‘up’ position (as shown in FIG. 2), a lower support frame 30, disposed underneath the transparent top plate 29 to support the transparent top plate 29, and a tilt plate 24, connected by a pivot connector 27 to the main frame 25 of the 3D printer, and a tilt actuator 31 disposed underneath the tilt plate 24 opposite to the pivot connector 27 to move the tilt plate 24 along with the transparent top plate 29 and the lower support frame 30 downwards to a ‘down’ position to separate the transparent top plate 29 from the transparent bottom separation layer 18 of the tank 16.

As aforementioned, one end of the tilt plate 24 is connected by a pivot connector 27 to the main frame 25 of the 3D printer. The pivot connector 27 may be realized with a hinge, as shown in FIG. 2, wherein an additional spacer 27a with the similar thickness of the tilt plate 24 may also be included to make the pivot connection level. In other embodiments, the spacer 27a may be integrated as a part of the hinge; that is, one hinge leaf is thicker than the other hinge leaf. Another alternative is to integrate the spacer 27a into the main support frame 25 so that a hinge with two equal-thickness hinge leaves may be used. It should be noted that the use of a hinge as the pivot connector 27 is only for illustrative purpose, instead of restrictive. The tilt actuator 31 is disposed below the tilt plate 24 at the other end away from the pivot connector 27. When the tilt plate 24 is lowered to a ‘down’ position by the tilt actuator 31, the tilt plate 24 along with the transparent top plate 29 and the lower support frame 30 will be separated from the transparent bottom separation layer 18 of the tank 16. As the tilt plate 24 is connected by the pivot connector 27 to the main frame 25, the movement to the ‘down’ position appears rotational and shows a tilting effect. As a result, when the tilt plate 24 is moved to the ‘down’ position, the transparent bottom separation layer 18 will lose the support of the transparent top plate 29 and the lower support frame 30 from below to cause a slight slack in the transparent bottom separation layer 18 to make the lifting and peeling of the solidified photopolymer from the transparent bottom separation layer 18 easier.

The tilt actuator 31 provides the force to move the tilt plate 24 upwards or downwards. It should be noted that the tilt actuator 31 may apply the force directly to the tilt plate 24 or through the use of a spring or other similar elements to exert the force to move the tilt plate 24.

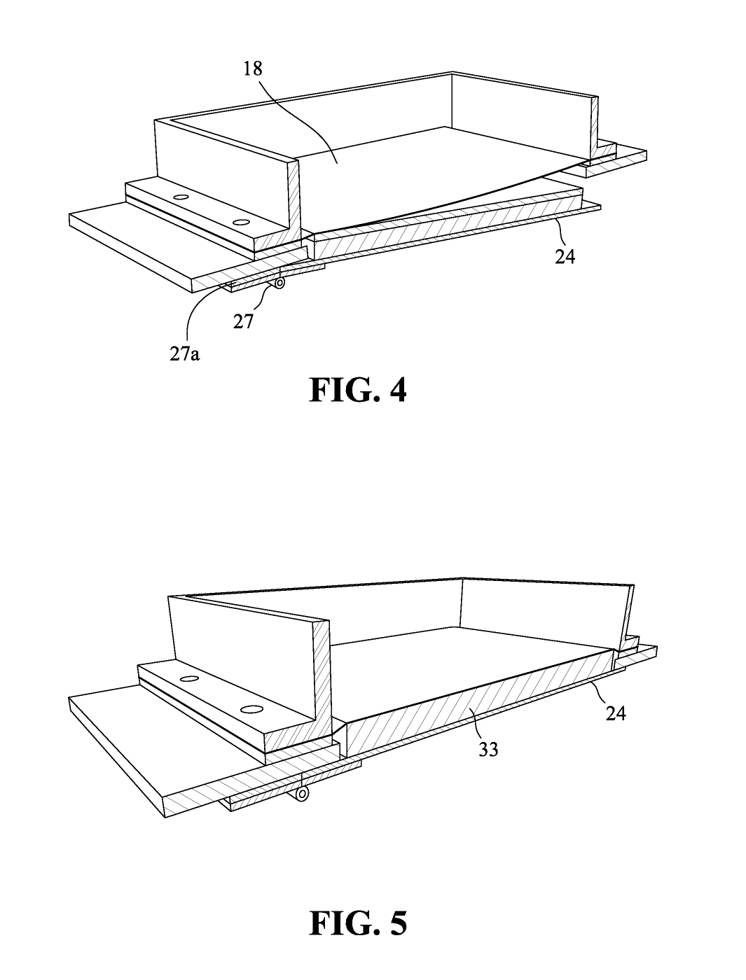

FIG. 3 and FIG. 4 show schematic views of how the position of the tilt plate 24 affects the slack of the transparent bottom separation layer 18. FIG. 3 shows a schematic view of the tilt plate of the embodiment in an ‘up’ position, and FIG. 4 shows a schematic view of the tilt plate of the embodiment in a ‘down’ position. As shown in FIG. 3, when the tilt plate 24 is in an ‘up’ position, the tilt plate 24, the lower support frame 30 and the transparent top plate 29 are stacked to support the transparent bottom separation layer 18. However, when the tilt plate 24 is in a ‘down’ position as in FIG. 4, the transparent bottom separation layer 18 is no longer supported by the stacked tilt plate 24, lower support frame 30 and transparent top plate 29. As a result, a slight slack occurs in the transparent bottom separation layer 18 and therefore allows for a more desirable peel angle to make the peeling of the solidified photopolymer easy.

It is also worth noting that the actuator 10 to move the build arm 12 along the z-axis linearly can be realized by, but not restricted to, a motor. Similarly, the tilt actuator 31 to tilt the tilt plate 24 downwards can also be realized by, but not restricted to, a motor. The tank 16 may be fixed to the main support frame 25 for further stability. In addition, the transparent bottom separation layer is made of a low surface energy material. Low surface energy materials are desired due to their non-stick properties. Examples of transparent or translucent low surface energy materials include, but are not limited to the fluoropolymers FEP, PTFE, PFA, MFA, and so on.

FIG. 5 shows a schematic view of an apparatus for peeling in the production of three-dimensional objects according to another exemplary embodiment. The present embodiment is similar to the embodiment in FIG. 2, except that in the present embodiment, a flat panel display device 33 is included to replace the transparent top plate 29, and the lower support frame 30. For example, the flat panel display device 33 may be a liquid crystal display. The flat panel display device 33 is attached to the tilt plate 24 to perform exposure for the layer solidification. The flat panel display device 33 also serves the function of supporting the transparent bottom separation layer 18 in a flat position. In another embodiment, the transparent top plate 29 can also be included between the flat panel display device 33 and the transparent bottom separation layer 18.

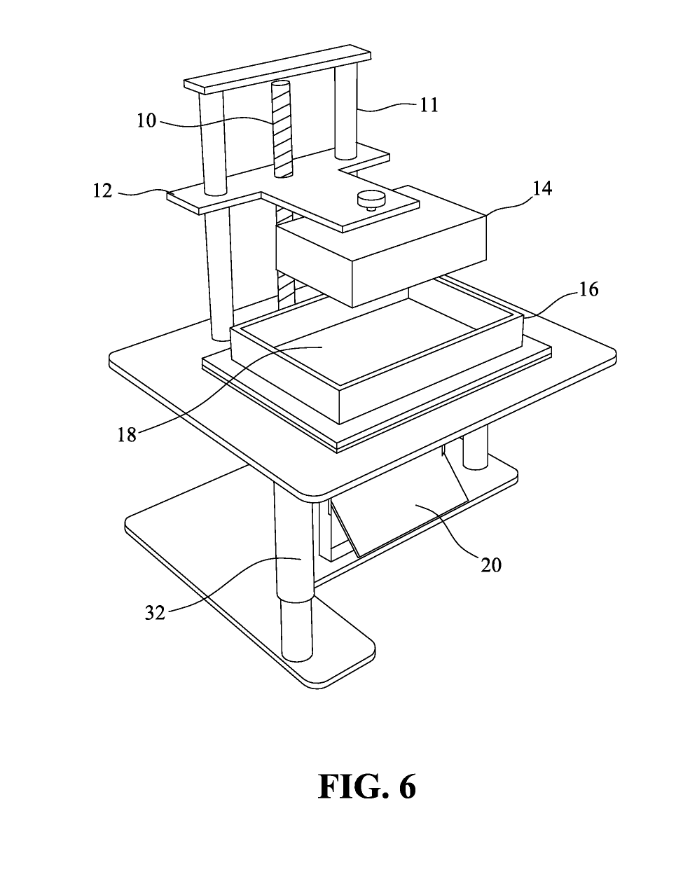

FIG. 6 shows a schematic view of another embodiment of a 3D printer according to an exemplary embodiment. As shown in FIG. 6, a mirror 20 is placed underneath the main support frame 25 to reflect light projected by a light source (not shown) upwards to pass through the main support frame 25, the lower support frame 30, the transparent top plate 29, and the transparent bottom separation layer 18 of the tank 16 to solidify the liquid photopolymer 22. In the present embodiment, one or more extendable and retractable support legs 32 are also included to allow for adjustment through a wide-range of x and y-axis resolutions. By extending the support legs 32, the distance between the mirror 20 and the liquid photopolymer 22 is larger so that the projected light image is larger and the x and y-axis resolutions are reduced. On the other hand, the support legs 32 can be retracted to reduce the distance between the mirror 20 and the liquid photopolymer 22 so that the projected light image is smaller and the x and y-axis resolutions are increased.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An apparatus for peeling in the production of producing three-dimensional (3D) objects, applicable to a 3D printer having a tank to hold a liquid photopolymer, the tank having a transparent bottom separation layer to allow light from a light source to pass through the transparent bottom separation layer of the tank to solidify the liquid photopolymer; the apparatus comprising:
a transparent top plate, disposed underneath the transparent bottom separation layer to support the transparent bottom separation layer of the tank when in an ‘up’ position;
a lower support frame, disposed underneath the transparent top plate to support the transparent top plate; and
a tilt assembly, comprising a tilt plate with one end connected by a pivot connector to the 3D printer, and an actuator disposed underneath the tilt plate at the opposite end to the pivot connector to move the tilt plate along with the transparent top and the lower support frame downwards to a ‘down’ position to separate the transparent top plate from the transparent bottom separation layer of the tank;
wherein the apparatus being disposed underneath the transparent bottom separation layer of the tank.

2. The apparatus for peeling in the production of 3D objects as claimed in claim 1, wherein the transparent bottom separation layer is made of a low surface energy material.

3. An apparatus for peeling in the production three-dimensional (3D) objects, applicable to a 3D printer having a tank to hold a liquid photopolymer, the tank having a transparent bottom separation layer to allow light from a light source to pass through the transparent bottom separation layer of the tank to solidify the liquid photopolymer;
the tank being supported by a support frame with a transparent top plate from underneath; the apparatus comprising:
a tilt plate, disposed underneath the support frame of the 3D printer;
a pivot connector, connecting one end of the tilt plate to the support frame of the 3D printer; and
a tilt actuator, disposed underneath the tilt plate at the opposite end to the pivot connector to move the tilt plate downwards to a ‘down’ position;
wherein when the tilt plate being moved to an ‘up’ position, the support frame with the transparent top plate supporting the transparent bottom separation layer of the tank from below; and when the tilt plate being moved to a ‘down’ position, the support frame with the transparent top plate being separated from the transparent bottom separation layer of the tank.

4. The apparatus for peeling in the production of 3D objects as claimed in claim 3, wherein the transparent bottom separation layer is made of a low surface energy material.
